(19) United States
(12) Patent Application Publication
(10) Pub. No.: US 2014/0326665 A1
(43) Pub. Date: Nov. 6, 2014

(54) Pressure Monitoring and Pump Speed Control for a Reverse Osmosis System

(71) Applicant: CRESTRON ELECTRONICS, INC., Rockleigh, NJ (US)

(72) Inventor: George Feldstein, Cresskill, NJ (US)

(73) Assignee: Crestron Electronics, Inc., Rockleigh, NJ (US)

(21) Appl. No.: 13/886,335

(22) Filed: May 3, 2013

(51) Int. Cl. C02F 1/00; C02F 1/44

(52) U.S. Cl. CPC C02F 1/008; C02F 1/441
USPC 210/637; 210/110; 210/652

(57) ABSTRACT

An apparatus, for use with a reverse osmosis system comprising a feed input, a concentrate output, and a permeate output, includes (i) at least one pressure sensor operative to measure a pressure of at least the permeate output of the reverse osmosis system and to generate a signal indicative of the pressure of at least the permeate output of the reverse osmosis system and (ii) at least one controller operative to adjust a speed of at least a first pumping mechanism based at least in part on the signal indicative of the pressure of at least the permeate output of the reverse osmosis system. The first pumping mechanism comprises at least one of: (i) a fluid input coupled to at least the permeate output of the reverse osmosis system; and (ii) a fluid output coupled to at least the feed input of the reverse osmosis system.

### BACKGROUND OF THE INVENTION

1. Technical Field

This invention relates generally to techniques and devices for providing more effective monitoring and adjustment of operational conditions within a reverse osmosis system or other filtration system, and more particularly to techniques and devices that provide improved pressure monitoring and/or pump speed control in such a system.

2. Background Art

The present invention is useful for enhancing the performance of a reverse osmosis system. Although reverse osmosis is perhaps best known for its use in connection with desalinization, it is also widely used to purify fresh water for medical, industrial, and domestic applications. In addition to water, reverse osmosis is also used in connection with other fluids. such as milk and wine, for example, in agricultural applications.

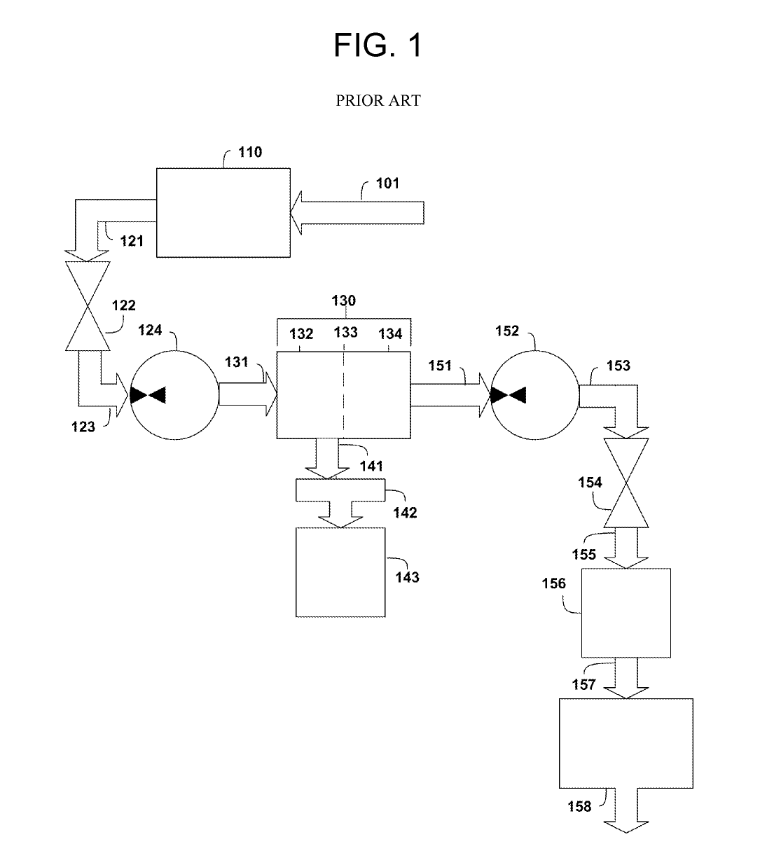

FIG. 1 is a block diagram which depicts a reverse osmosis system according to the prior art. Input 101 permits a solvent to enter. This solvent may be water, such as sea water, brackish water, tap water or wastewater, and typically has various solutes (including, but not limited to, sea salt) dissolved therein.

Pretreatment assembly 110 may be included in order to prepare the input 101 for processing by the reverse osmosis (RO) filter 130 by, for example, removing particulates and/or chemicals which can damage the membrane 133 within RO filter 130. Certain embodiments may omit pretreatment assembly 110.

The output 121 from pretreatment assembly 110 is coupled to a valve 122 which serves to modulate the pressure and flow rate of the input 123 to feed pump 124. For example, valve 122 may be configured to shut off input 123 to feed pump 124 (and hence input 131 to RO filter 130) under certain conditions. Valve 122 is preferably electronically actuated, and may be of any suitable type, including but not limited to solenoid valves and/or ball valves.

A solvent having solutes dissolved therein (often called “feed”) enters the RO filter 130 through input 131. In order to force solvent through membrane 133 within RO filter 130, it is necessary to apply a pressure in excess of the osmotic pressure to the input 131 of the RO filter 130. Feed pump 124 (sometimes referred to as a “booster pump”) may be used to apply this pressure to the input 131 of the RO filter 130. Feed pump 124 may have a motor coupled thereto and/or incorporated therein. Feed pump 124 may be of any suitable type, including but not limited to displacement pumps (e.g., gear, screw, vane, piston, or diaphragm pumps) and rotodynamic pumps (e.g., centrifugal pumps).

RO filter 130 consists of a region of high solute concentration 132 and a region of low solute concentration 134 separated by a semipermeable membrane 133, which has pores of a size (often as small as 0.1 nm) which allows the solvent but not the solute to pass therethrough. Membrane 133 may be made from a variety of materials, including but not limited to, cellulose acetate (e.g., cellulose triacetate (CTA) or cellulose acetate blend (CAB)) or a thin film composite (TFC) which may include, for example, composite polyamide (CPA). Other suitable TFC membranes may comprise one or more of polyamide, polymide, polysulfone, polyethersulfone, polyurea, and polyetherurea. Membrane 133 may be formed in a variety of configurations, including but not limited to spiral-wound, hollow-fiber, tubular and/or plate and frame. Examples of suitable materials and configurations for membrane 133 include those described in a paper entitled “Commercial RO Technology,” published by Hydranautics and dated Jan. 23, 2001, which is submitted herewith and incorporated by reference herein.

A solvent having solutes dissolved therein (often called “feed”) enters the region of high solute concentration 132 at high pressure through input 131. This pressure forces the solvent through the semipermeable membrane 133 from the region of high solute concentration 132 to the region of low solute concentration 134, while the solutes remain within the region of high solute concentration 132. This movement of the solvent (but not the solutes) into the region of the low solute concentration 134 results in a further decrease in the solute concentration within the region of low solute concentration 134, thereby forming a purified solvent referred to as the “permeate,” which exits at low pressure through permeate outlet 151. By contrast, the movement of the solvent (but not the solutes) from the region of high solute concentration 132 will result in a further increase in the concentration of solute within the solvent which remains within this region, thereby forming a highly concentrated fluid, referred to as a “concentrate” or “retentate,” which exits at high pressure through concentrate outlet 141.

In desalinization, the feed may comprise saltwater or brackish water, the permeate may comprise purified fresh water, and the concentrate may comprise concentrated brine. In other forms of water purification, the feed may consist of fresh but impure water (e.g., rain water, tap water or waste water), the permeate may comprise purified and/or deionized fresh water, and the concentrate may comprise highly impure water. Although in the aforementioned applications, the concentrate is typically viewed as an undesirable waste product, in other applications, the concentrate is viewed as desirable, and sometimes is even considered more desirable than the permeate. For example, reverse osmosis is often used within the dairy industry to produce a more concentrated form of milk to reduce shipping costs, or to process whey in order to produce whey powder for use as a nutritional supplement.

Concentrate outlet 141 is coupled to a restrictor 142, such an orifice plate, which serves to lower the pressure of the concentrate outlet 141 such that the concentrate may be stored in concentrate storage tank 143. The concentrate within concentrate storage tank 143 may then be discarded as waste or output as a desirable end-product (e.g., in the aforementioned dairy applications).

Other arrangements may include additional and/or alternative components for distribution and/or storage of concentrate. For example, concentrate outlet 141 may be coupled to input 131 so that the concentrate is fed back into RO filter 130 in a configuration known as “concentrate recirculation,” or concentrate outlet 141 may be coupled to an input of another RO filter to allow for recovery of additional permeate therefrom in a configuration known as “concentrate staging.”

Permeate output 151 is coupled to permeate pump 152 (also known as a “permeate pump”), which may be used to provide additional pressure to increase the flow rate of permeate output 151. As with feed pump 124, permeate pump 152 may have a motor coupled thereto and/or incorporated therein. Permeate pump 152 may be of any suitable type, including but not limited to displacement pumps (e.g., gear, screw, vane, piston, or diaphragm pumps) and rotodynamic pumps (e.g., centrifugal pumps).

The output 153 of permeate pump 152 is coupled to check valve 154, which serves to prevent backflow from downstream components such as storage tank 156. In the absence of a backflow prevention device such as check valve 154, backflow entering RO filter 130 through permeate output 151 (e.g., when storage tank 156 is at capacity) could damage membrane 133, for example, by causing membrane envelopes to expand and/or rupture. Other arrangements may utilize other types of backflow prevention devices, including but not limited to an air gap. a double check (DC) valve and/or a reduced pressure (RP) device.

The output 155 of check value 154 is coupled to a permeate storage tank 156. Permeate storage tank 156 (which may be pressurized and/or vented in some embodiments) may be utilized to store at least a portion of the permeate for later use. An output 157 of permeate storage tank 156 may be coupled to a distributor 158. Distributor 158 may be utilized to output at least a portion of the permeate (e.g., to a faucet). In some embodiments, distributor 158 may include a pump known as a “delivery pump” or “demand pump.”

Other arrangements may include additional and/or alternative components for distribution and/or storage of permeate. For example, in an arrangement known as permeate staging or two-pass filtering, output 153 and/or 155 could be fed into a second RO filter to further purify the permeate. This may be particularly beneficial in applications where input 101 contains a particularly high concentration of solutes, such as seawater desalinization or wastewater treatment.

Energy usage is often the single largest factor in the cost of reverse osmosis systems, and can account for 20-30% of the total cost of water. An energy analysis of one reverse osmosis system, as described in FILMTEC Membranes Tech Fact No. 609-00472, submitted herewith and disclosed by reference herein, revealed that almost three-quarters of the energy cost was the result of pressure loss across the membrane, and more particularly within the feed-to-permeate section. The second largest factor in energy cost was inefficiency of the pumps used to apply pressure to the fluid, including the use of throttling valves to control flow from pumps.

The prior art recognizes these problems and discloses various expedients with a view to solving these problems. For example, U.S. Patent Application Publication No. 2011/0049050, the disclosure of which is incorporated by reference herein, describes an arrangement in which a raw water pump is controlled in response to a flow rate measurement of the raw water between the raw water pump and a reverse osmosis element, and in which a control valve within a concentrate conduit may be controlled in response to a flow measurement provided by a flow meter in the concentrate conduit. Application of these techniques to the FIG. 1 arrangement would include controlling pump 124 in response to a flow measurement of input 131 and controlling restrictor 142 in response to a flow measurement of output 141.

International Patent Application Publication No. WO 96/41675, the disclosure of which is incorporated by reference herein, describes an arrangement in which the flow of concentrate is automatically adapted to the flow of raw water so as to maintain a constant ratio between the flow of concentrate and the flow of raw water and/or a constant ratio between the flow of permeate and the flow of concentrate. The flow of raw water is detected by a flow meter disposed upstream of the pump which provides for the filter pressure and is used to control the flow cross-section and flow resistance in the concentrate outlet conduit. Application of these techniques to the FIG. 1 arrangement would include controlling restrictor 142 in response to a flow measurement of input 131.

U.S. Pat. No. 4,626,346, the disclosure of which is incorporated by reference herein, describes an arrangement which includes a pressure sensing switch means coupled to sense the pressure in a water storage compartment. When the sensed pressure increases to a point above a predetermined value, the pressure sensing switch means opens a switch thereby interrupting operation of the reverse osmosis system. The inventors have noted that this arrangement, would be unable to provide any control finer-grained than so-called “bang-bang” (i.e., on-off) control.

Moreover, Aquatec International Inc. of Irvine, Calif., USA (hereinafter “Aquatec”) sells variable speed delivery/demand pumps (e.g., DDP series models 55X and 58XX) which vary their speed based on the pressure associated with their outputs (e.g., a pump located within distributor 158 of FIG. 1 which changes its speed based on a pressure associated with its output), but these variable-speed pumps are not suitable for use as either feed pumps (e.g., pump 124 in FIG. 1) or as permeate pumps (e.g., pump 152 in FIG. 1). Instead, Aquatec sells feed pumps (e.g., CDP series models 68XX and 88XX) which do not offer variable speed, but rather only allow for “bang-bang” (i.e., on-off) control using components such as pressure switches (e.g., PSW series), vacuum switches (e.g., VSW series), tank level controllers (e.g., TLC series) and/or electronic shut-off valves (e.g., ESO series). Likewise, Aquatec's permeate pumps (e.g., ERP-1000) only allow for “bang-bang” (i.e., on-off) control using hydraulic shut-off valves (e.g., ASV series). Literature describing the aforementioned products commercially available from Aquatec is submitted herewith and incorporated by reference herein. Such arrangements which would involve controlling valve 122 and/or pump 124 responsive to pressure in output 155 and/or tank 156.

Some conventional reverse osmosis systems, such as those commercially available from Water Tec of Tuscon (Ariz., USA) and described in the Instruction Manual submitted herewith and incorporated by reference herein, include pressure gauges which display the pressure currently present at various points within the reverse osmosis system. The inventor has noted that these conventional arrangements fail to provide monitoring of differences between pressures at various points within the system (e.g., the difference between input pressure and output pressure) and/or variations in pressure over time (e.g., increasing or decreasing pressure), both of which can be important indicators of conditions within the filter. Moreover, the inventor has noted that these conventional arrangements require a user to manually monitor the gauges and manually make adjustments to the operation of the filter responsive to the pressure measurements displayed by the gauges.

There is a long-felt need for an arrangement which provides more effective monitoring and adjustment of operational conditions within a reverse osmosis system or other filtration system in order to ensure optimal operation. In particular, there is a long-felt need for an arrangement which provides improved pressure monitoring and/or pump speed control in such a system.

### SUMMARY OF THE INVENTION

It is to be understood that both the general and detailed descriptions that follow are exemplary and explanatory only and are not restrictive of the invention.

### DISCLOSURE OF INVENTION

A first object of the invention is to provide for more effective monitoring of conditions within a filtration system. This object may be accomplished at least in part by measuring a pressure of a given input of the filtration system, measuring a pressure of a given output of the filtration system, and generating a signal indicative of a difference between the pressure of the given input of the filtration system and the pressure of the given output of the filtration system.

The signal may be transmitted over at least one of a wired and a wireless connection to facilitate remote monitoring of the fluid processing system. Multiple values of the signal may be recorded at differing times on a storage medium to facilitate detection of variations in the signal.

In one embodiment in which the filtration system comprises a reverse osmosis filter, the signal may be indicative of the difference between the pressure of an input of the reverse osmosis filter and the pressure of the permeate output of the reverse osmosis filter. In another embodiment in which the filtration system comprises at least one pretreatment filter within a reverse osmosis system, the given output of the fluid processing system may be coupled to an input of a reverse osmosis filter within the reverse osmosis system.

A second object of the invention is to provide for more accurate adjustment of pressure and pump speed within a reverse osmosis system comprising a feed input, a concentrate output, and a permeate output. In some embodiments, this object is accomplished at least in part by adjusting a speed of at least a first pumping mechanism based at least in part on pressure of the permeate output of the reverse osmosis system.

In other embodiments, this object is accomplished at least in part by adjusting a speed of at least a first pumping mechanism based at least in part on a signal indicative of a difference between a pressure of the feed input of the reverse osmosis system and a pressure of the permeate output of the reverse osmosis system. The speed of at least the first pumping mechanism may adjusted so as to maintain the difference between the pressure of at least the feed of the reverse osmosis system and the pressure of at least the permeate output of the reverse osmosis system at a substantially constant level.

Adjusting the speed of the first pumping mechanism may include increasing or decreasing the speed of the first pumping mechanism from a first non-zero value to a second non-zero value without enabling or disabling the first pumping mechanism. The speed of at least the first pumping mechanism may be adjusted so as to at least partially compensate for variations in a pressure of the feed input of the reverse osmosis system.

The speed of the at least first pumping mechanism may be adjusted so as to maintain the pressure of the permeate output of the reverse osmosis system at a substantially constant level. For example, the pressure of the permeate output of the reverse osmosis system may be maintained within a range of approximately 3 pounds per square inch (psi) and 5 psi.

The present invention seeks to overcome or at least ameliorate one or more of several problems, by providing more effective monitoring of conditions (e.g., filter performance) within, and/or more accurate adjustment of feed pressure within, a reverse osmosis system in order to ensure optimal operation.

### BRIEF DESCRIPTION OF DRAWINGS

The accompanying figures further illustrate the present invention.

### BRIEF DESCRIPTION OF THE SEVERAL VIEWS OF THE DRAWING

FIG. 1 is a block diagram depicting a reverse osmosis system according to the prior art.

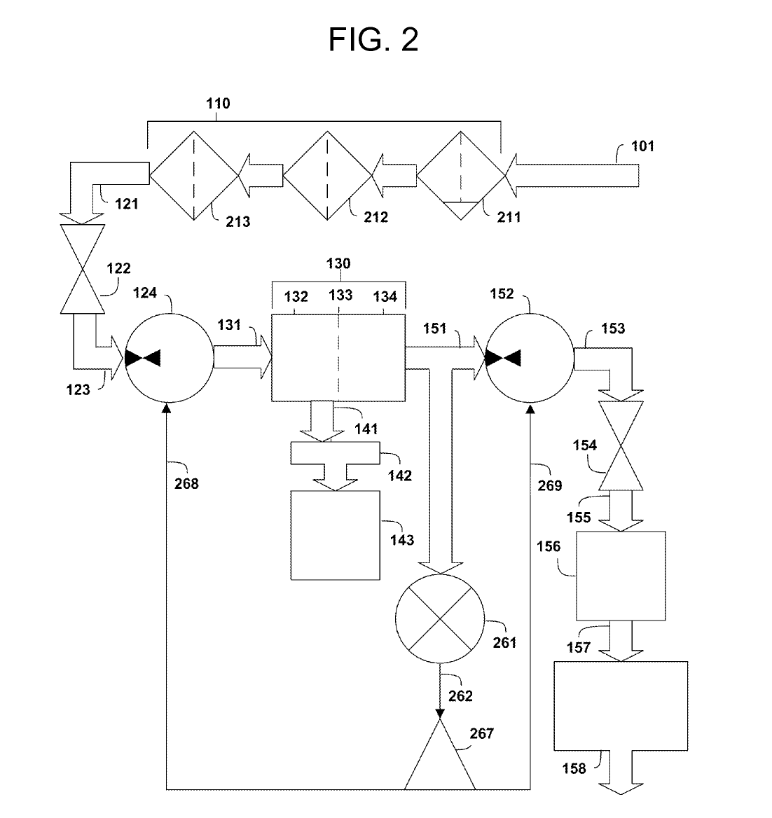

FIG. 2 is a block diagram depicting a reverse osmosis system according to a first illustrative embodiment of the present invention.

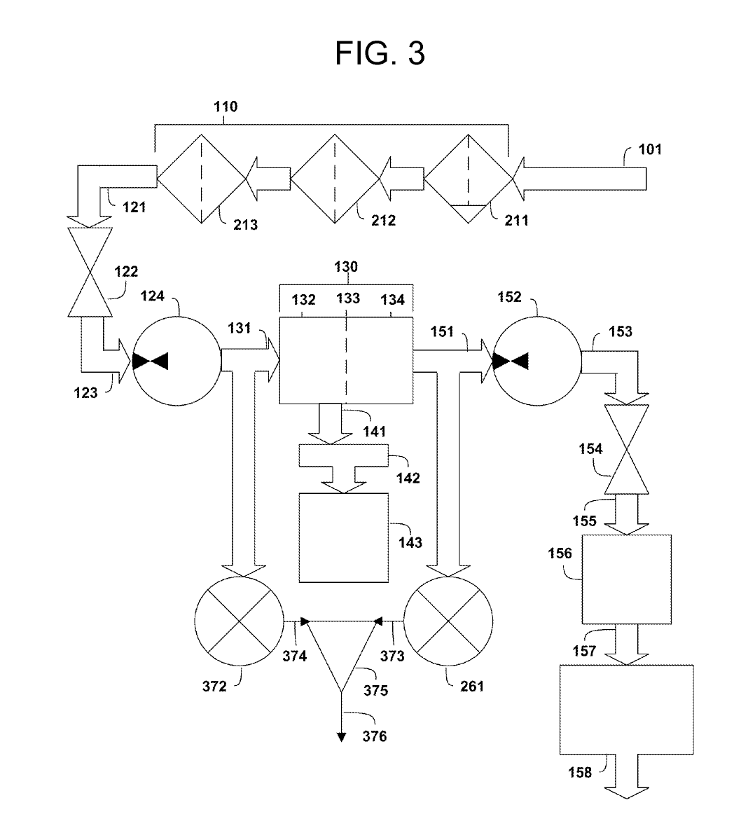

FIG. 3 is a block diagram depicting a reverse osmosis system according to a second illustrative embodiment of the present invention.

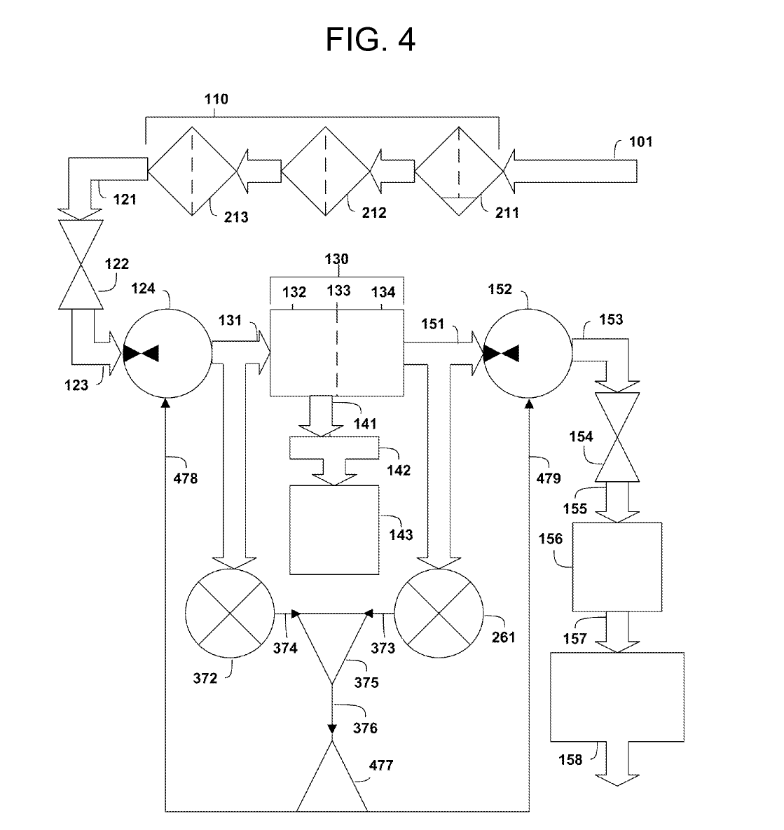

FIG. 4 is a block diagram depicting a reverse osmosis system according to a third illustrative embodiment of the present invention.

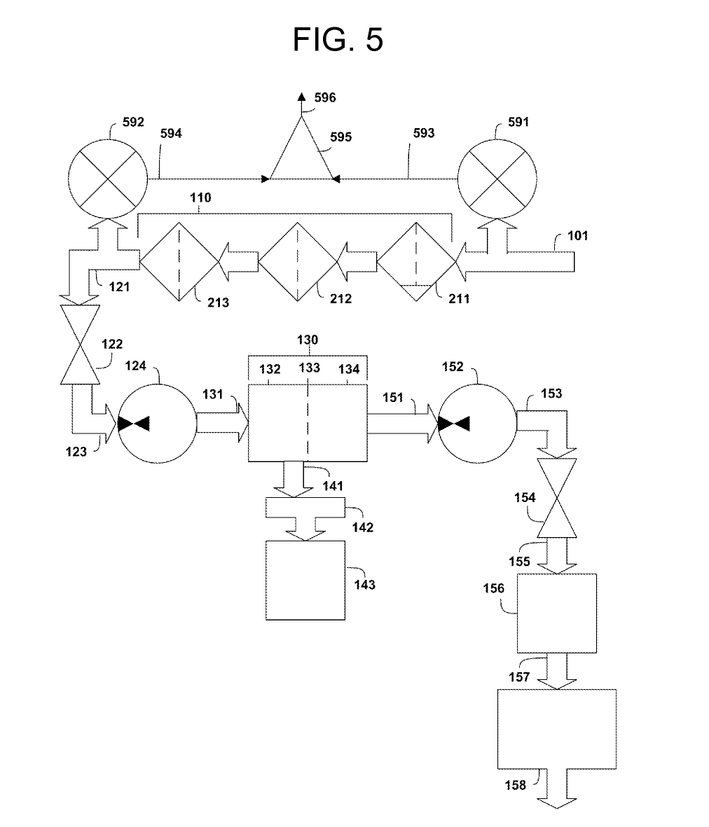

FIG. 5 is a block diagram depicting a reverse osmosis system according to a fourth illustrative embodiment of the present invention.

### LIST OF REFERENCE NUMBERS FOR THE MAJOR ELEMENTS IN THE DRAWING

The following is a list of the major elements in the drawings in numerical order.
101 input (of pretreatment assembly 110)
110 pretreatment assembly
111 sediment filter (within pretreatment assembly 110)
112 first carbon filter (within pretreatment assembly 110)
113 second carbon filter (within pretreatment assembly 110)
121 output (of pretreatment assembly 110)
122 electro valve
123 input (of feed pump 124)
124 feed pump
130 reverse osmosis (RO) filter
131 input (of RO filter 130)
132 region of high solute concentration (within RO filter 130)
133 semipermeable membrane (within RO filter 130)
134 region of low solute concentration (within RO filter 130)
141 concentrate output (of RO filter 130)
142 restrictor (for concentrate outlet 141)
143 concentrate storage tank
151 permeate output (of RO filter 130)
152 permeate pump
153 output (of permeate pump 152)
154 check valve
155 input of permeate storage tank 156
156 permeate storage tank
157 output of permeate storage tank 157
158 permeate distributor
261 pressure sensor (for permeate output 151)
262 pressure signal (from pressure sensor 261)
267 control logic (for permeate pressure signal 262)
268 pump speed control signal (for feed pump 124)
269 pump speed control signal (for permeate pump 152)
372 pressure sensor (for RO filter input 131)
373 pressure signal (from pressure sensor 372)
374 pressure signal (from pressure sensor 261)
375 control logic (for pressure signals 373 and 374)
376 differential pressure signal (for pressure signals 373 and 374)
487 control logic (for differential pressure signal 376)
488 control signal (for feed pump 124)
489 control signal (for permeate pump 152)
591 pressure sensor (for input 101 of pretreatment assembly 110)
592 pressure sensor (for output 121 of pretreatment assembly 110)
593 pressure signal (from pressure sensor 591)
594 pressure signal (from pressure sensor 592)
595 control logic (for pressure signals 593 and 594)
596 differential pressure signal (for pressure signals 593 and 594)

### DETAILED DESCRIPTION OF THE INVENTION

### Mode(s) for Carrying Out the Invention

The preferred embodiment of the present invention is described herein in the context of water filtration using a reverse osmosis system, but is not limited thereto, except as may be set forth expressly in the appended claims. For example, Although the preferred embodiments of the present invention are described herein in the context of water filtration, one skilled in the art would understand that other fluids may be used, such as wine or milk.

FIG. 2 is a block diagram depicting a reverse osmosis system according to a first illustrative embodiment of the present invention. FIG. 2 includes most of the components discussed hereinabove with reference to FIG. 1, and these components function in a similar manner within the FIG. 2 embodiment as in the FIG. 1 embodiment. However, FIG. 2 includes additional components which are not present within the FIG. 1 embodiment.

In the FIG. 2 embodiment, pretreatment assembly 110 comprises sediment filter 211 and activated carbon filters 212 and 213. It is important to note that this arrangement is exemplary. Depending on the composition of the input 101 and/or the configuration of the filter 130, the pretreatment assembly 110 could include differing numbers, types and/or orderings of components. For example, the pretreatment assembly 110 could include equipment for hollow fiber microfiltration, capillary ultrafiltration, gravity filtration, lime clarification, flocculation and/or coagulation in addition to or instead of sediment filter 211 and/or activated carbon filters 212 and 213.

Sediment filter 211 may be included in order to trap particles, which may include, but need not be limited to, rust and/or calcium carbonate. Other embodiments may omit sediment filter 211, while still other embodiments may include additional sediment filters with equal and/or decreasing pore sizes (e.g., decreasing from 5 μm to 1 μm). In one embodiment, a single string-wound polypropylene filter may be used with pores of approximately 1 μm.

Activated carbon filters 212 and 213 may be included in order to trap, for example, organic chemicals and/or chlorine. In one embodiment, activated carbon filters 212 and 213 may be capable of removing particles of approximately 5 μm. In other embodiments, activated carbon filters 212 and 213 may be configured to remove particles of other sizes (e.g., decreasing from 50 μm to 0.5 μm). In some embodiments, including but not limited to those in which membrane 133 within RO filter 130 is formed from cellulose acetate rather than a thin film composite, activated carbon filters 212 and 213 may be omitted, or activated carbon filters 112 and 113 may be included after, rather than before, RO filter 130.

In a reverse osmosis system, there is an inverse relationship between pump speed (e.g., the speed of feed pump 124 and/or permeate pump 152) and the pressure of permeate output 151: as pump speed decreases, permeate output pressure increases. There is also an inverse relationship between the pressure of permeate output 151 and the efficiency of RO filter 130, hence the efficiency of RO filter 130 could often be enhanced by maintaining a substantially constant pressure within permeate output 151, for example, a pressure of approximately 3 to 5 psi.

In the FIG. 2 embodiment, permeate output 151 is coupled to a pressure sensor 261 which may be, for example, an analog pressure sensor. Many types of pressure sensors, including but not limited to pressure transducers and/or pressure transmitters, may be used in connection with embodiments of the present invention. Pressure sensor 261 generates a signal 262 indicative of the pressure within permeate output 151. In some embodiments, signal 262 may comprise an electrical signal having a voltage, current, and/or frequency which varies in direct and/or indirect proportion to the pressure within permeate output 151.

Signal 262 may be coupled to control logic 267, which generates feed pump control signal 268 and permeate pump control signal 269 based on signal 262. Pump control signals 268 and 269 are respectively coupled to, and operative to control the speeds of, feed pump 124 and permeate pump 152.

In one embodiment, feed pump 124 and/or permeate pump 152 may be driven by one or more electric motor units, and at least one of the one or more electric motor units has at least one variable speed drive (VSD) incorporated therein. Feed pump 124 and permeate pump 152 may each be driven by a respective electric motor, or they may be driven by a common electric motor (either with a respective VSD for each pump or with a common VSD for both pumps).

In a preferred embodiment, pressure sensor 261 and control logic 267 implement a closed control loop which controls (e.g., servos) the speeds of pumps 124 and/or 152 in order to maintain a substantially constant pressure within permeate output 151, for example, a pressure of approximately 3 to 5 psi. Adjusting the speeds of pumps 124 and/or 152 based on pressure within permeate output 151 using a closed control loop is preferable to maintaining a constant pump speed because the closed control loop is better able to account for pressure variations within permeate output 151 caused by, for example, pressure variations within inputs 131 and/or 101.

Although the FIG. 2 embodiment shows control logic 267 generating two control signals 268 and 269, thereby controlling the speed of both pumps 124 and 152, other embodiments may omit one of these control signals and thereby control the speed of only a single pump. Furthermore, although the FIG. 2 embodiment shows control logic 267 which generates pump control signals 268 and 269 from a pressure signal 262 generated by pressure sensor 261, other arrangements fall within the scope of the present invention. For example, pressure sensor 261 could be operative to directly generate pump control signals 268 and/or 269 (e.g., by having control logic 267 incorporated therein), or pumps 124 and/or 152 could operate directly on pressure signal 262 (e.g., by having control logic 267 incorporated therein).

FIG. 3 is a block diagram depicting a reverse osmosis system according to a second illustrative embodiment of the present invention. As with FIG. 2, FIG. 3 includes most of the components discussed hereinabove with reference to FIG. 1. These components function in a similar manner within the FIG. 3 embodiment as in the FIG. 1 embodiment.

FIG. 3, like FIG. 2, includes a pressure sensor 261 coupled to permeate output 151 of RO filter 130. However, FIG. 3 also includes a pressure sensor 372 coupled to input 131 of RO filter 130. In some embodiments, at least one of pressure sensor 261 and pressure sensor 372 may comprise an analog pressure sensor. Rather than generating signal 262 for transmission to control logic 267 (as in FIG. 2), pressure sensor 261 generates a signal 374 for transmission to control logic 375. Likewise, pressure sensor 372 generates a signal 373 for transmission to control logic 375.

Signal 373 is indicative of the pressure in input 131 of RO filter 130, and signal 374 is indicative of the pressure in permeate output 151 of RO filter 130. In some embodiments, signals 373 and/or 374 may comprise electrical signals having a voltage, current, and/or frequency which varies in direct and/or indirect proportion to the pressure of input 131 and/or permeate output 151, respectively. Control logic 375 generates a signal 376, which is indicative of the difference between signal 373 and signal 374. Hence, signal 376 is indicative of the difference between the pressure in input 131 of RO filter 130 and the pressure in permeate output 151 of RO filter 130.

This pressure difference may be indicative of the condition of membrane 133 within RO filter 130. For example, the pores within membrane 133 may become clogged over time as the RO filter is used (a condition commonly referred to as “fouling” or “scaling”). This will result in an increased difference between the pressure of input 131 and the pressure of permeate output 151 because of the greater resistance provided by membrane 133 to the solvent. Fouling or scaling may result in decreased performance of the RO filter 130 (e.g., a given quantity of feed resulting in production of more concentrate and less permeate). An increased difference between the pressure of input 131 and the pressure of permeate output 151 will also increase the pressure which must be provided at input 131 to maintain a constant pressure at permeate output 151 and therefore can increase the energy requirements for, and decrease the energy efficiency of, RO filter 130.

Signal 376 may be output to allow a user to monitor the condition of RO filter 130, such as to indicate whether it is necessary to clean and/or replace membrane 133 (e.g., due to excessive “fouling” or “scaling”). For example, signal 376 could be coupled to a display mechanism, such as one or more light-emitting diodes (LEDs) capable of providing a binary indication (e.g., a light which either turns on or changes color responsive to the pressure difference exceeding a predetermined threshold) and/or a numeric display of the pressure difference. Additionally or alternatively, signal 376 could be transmitted over a wired or wireless network connection to facilitate remote monitoring of the RO filter 130. Additionally or alternatively, the value of signal 376 could be periodically and/or continuously recorded on a computer-readable storage medium (locally and/or remotely) to track changes over time.

Although FIG. 3 shows an arrangement in which signal 376 is generated by control logic 375 based on respective signals 373 and 374 generated by two pressure transducers 372 and 261, other arrangements fall within the scope of the invention. For example, signal 376 could be generated using a single differential pressure transducer having inputs respectively coupled to input 131 and permeate output 151. Signal 376 may comprise an electrical signal having a voltage, current and/or frequency which varies in direct and/or indirect proportion to the difference in the pressure of input 131 and the pressure of permeate output 151.

FIG. 4 is a block diagram depicting a reverse osmosis system according to a third illustrative embodiment of the present invention. FIG. 4 includes the components discussed hereinabove with reference to FIG. 3. These components function in a similar manner within the FIG. 4 embodiment as in the FIG. 3 embodiment.

However, in the FIG. 4 embodiment, signal 376 is input to control logic 477, which generates control signals 478 and 479 to control the speeds of feed pump 124 and permeate pump 152, respectively. In a preferred embodiment, pressure transducers 372 and 261 and control logic 375 and 477 implement a closed control loop which controls (e.g., servos) the speeds of pumps 124 and/or 152 so as to maintain a substantially constant difference in pressure between input 131 and output 151 of RO filter 130 (e.g., to attempt to hold pressure substantially constant across RO filter 130). Adjusting the speeds of pumps 124 and/or 152 based on the difference in pressure between input 131 and permeate output 151 using a closed control loop is preferable to merely maintaining a constant pump speed because the closed control loop is better able to account for pressure variations within permeate output 151 caused by, for example, pressure variations within inputs 131 and/or 101.

Although the FIG. 4 embodiment shows control logic 477 generating two control signals 478 and 479, thereby controlling the speed of both pumps 124 and 152, other embodiments may omit one of these control signals and thereby control the speed of only a single pump. Moreover, although FIG. 4 shows an arrangement in which signal 376 is generated by control logic 375 based on respective signals 373 and 374 generated by two pressure sensors 372 and 261, other arrangements fall within the scope of the invention. For example, signal 376 could be generated using a single differential pressure transducer having inputs respectively coupled to input 131 and output 151. Other embodiments could combine the functionalities of control logic 375 and control logic 377 within a single control logic unit operative to receive to generate one or more pump control signals 478 and 479 based directly on pressure signals 373 and 374, rather than generating and/or utilizing signal 376.

FIG. 5 is a block diagram depicting a reverse osmosis system according to a fourth illustrative embodiment of the present invention. As with FIG. 2, FIG. 5 includes most of the components discussed hereinabove with reference to FIG. 1. These components function in a similar manner within the FIG. 5 embodiment as in the FIG. 1 embodiment

The FIG. 5 embodiment includes a first pressure sensor 591 coupled to input 101 of pretreatment assembly 110 and a second pressure sensor 592 coupled to output 121 of pretreatment assembly 110. Pressure sensor 591 generates signal 593, which is indicative of the pressure in input 101 of pretreatment assembly 110 and pressure sensor 592 generates signal 594, which is indicative of the pressure in output 121 of pretreatment assembly 110.

Control logic 595 receives signals 593 and 594 from pressure transducers 591 and 592, respectively, and generates a signal 596, which is indicative of the difference between signal 593 and signal 594. Hence, signal 596 is indicative of the difference between the pressure in input 101 of pretreatment assembly 110 and the pressure in permeate output 121 of pretreatment assembly 110. This pressure difference is indicative of conditions within the pretreatment assembly 110.

In particular, the pressure difference may be indicative of the condition of one or more components (e.g., filters 211, 212 and/or 213) within pretreatment assembly 110. For example, in a manner similar to that discussed with reference to RO filter 130, pores within sediment filter 211 may become clogged as sediment filter 211 is used (a condition commonly referred to as “fouling” or “scaling”). This will result in an increase in the difference between pressure in input 101 and pressure in output 121, as well as reduced efficiency of sediment filter 211 and pretreatment assembly 110.

Signal 596 may be output to allow a user to monitor the condition of pretreatment assembly 110, and more particularly to indicate whether it is necessary to repair and/or replace component(s) within pretreatment assembly 110. For example, signal 596 could be coupled to a display mechanism, such as one or more light-emitting diodes (LEDs) capable of providing a binary indication (e.g., a light which either turns on or changes color responsive to the pressure difference exceeding a predetermined threshold) and/or a numeric display of the pressure difference. Additionally or alternatively, signal 596 could be transmitted over a wired or wireless network connection to facilitate remote monitoring of pretreatment assembly 110. Additionally or alternatively, the value of signal 596 could be periodically and/or continuously recorded on a computer-readable storage medium (locally and/or remotely) to track changes over time.

Although FIG. 5 shows an arrangement in which signal 596 is generated by control logic 595 based on respective signals 593 and 594 generated by two pressure transducers 591 and 592, other arrangements fall within the scope of the invention. For example, signal 596 could be generated using a single differential pressure transducer having inputs respectively coupled to input 101 and output 121.

Finally, those skilled in the art will appreciate that features of the FIGS. 2-5 embodiments may be combined with each other, and moreover that the present invention can be applied to many types of filtration or other fluid processing systems in addition to reverse osmosis systems.

### INDUSTRIAL APPLICABILITY

To solve the aforementioned problems, the present invention is a unique system which provides more effective monitoring and adjustment of operational conditions within a reverse osmosis system or other filtration system.

### Alternate Embodiments

Alternate embodiments may be devised without departing from the spirit or the scope of the invention. For example, the inventive device could be adapted to many types of fluid processing systems in addition to the reverse osmosis filtration systems described herein.

What is claimed is:

1. An apparatus for use with a reverse osmosis system comprising a feed input, a concentrate output, and a permeate output, said apparatus comprising:
at least one pressure sensor operative to measure a pressure of at least the permeate output of the reverse osmosis system and to generate a signal indicative of the pressure of at least the permeate output of the reverse osmosis system; and
at least one controller operative to adjust a speed of at least a first pumping mechanism based at least in part on the signal indicative of the pressure of at least the permeate output of the reverse osmosis system;
wherein the first pumping mechanism comprises at least one of:
a fluid input coupled to at least the permeate output of the reverse osmosis system; and
a fluid output coupled to at least the feed input of the reverse osmosis system.

2. The apparatus of claim 1, wherein the fluid input of the first pumping mechanism is coupled to at least the permeate output of the reverse osmosis system; and
wherein the fluid output of the first pumping mechanism is coupled to an input of at least one fluid storage device.

3. The apparatus of claim 1, wherein at least one of a current, a voltage, and a frequency of the signal generated by the at least one pressure sensor is at least in part proportional to the pressure of at least the permeate output of the reverse osmosis system.

4. The apparatus of claim 1, wherein at least the first pumping mechanism is coupled to a variable speed drive, and wherein adjusting the speed of at least the first pumping mechanism comprises utilizing the variable speed drive.

5. The apparatus of claim 1, wherein adjusting the speed of at least the first pumping mechanism comprises increasing or decreasing the speed of at least the first pumping mechanism from a first non-zero value to a second non-zero value without enabling or disabling at least the first pumping mechanism.

6. The apparatus of claim 1, wherein the pressure of at least the permeate output of the reverse osmosis system is substantially lower than a pressure of at least the concentrate output of the reverse osmosis system.

7. The apparatus of claim 1, wherein the at least one controller is operative to adjust the speed of at least the first pumping mechanism so as to at least partially compensate for at least one variation in a pressure of at least the feed input of the reverse osmosis system.

8. The apparatus of claim 1, wherein the at least one controller is operative to adjust the speed of at least the first pumping mechanism so as to maintain the pressure of at least the permeate output of the reverse osmosis system at a substantially constant level.

9. The apparatus of claim 1, wherein the at least one controller is further operative to adjust a speed of at least a second pumping mechanism based at least in part on the signal indicative of the pressure of at least the permeate output of the reverse osmosis system;
wherein at least the first pumping mechanism comprises a fluid output coupled to at least the feed input of the reverse osmosis system; and
wherein at least the second pumping mechanism comprises a fluid input coupled to at least the permeate output of the reverse osmosis system.

10. A method for use with a reverse osmosis system comprising a feed input, a concentrate output, and a permeate output, said method comprising:
measuring a pressure of at least the permeate output of the reverse osmosis system;
generating a signal indicative of the pressure of at least the permeate output of the reverse osmosis system; and
adjusting a speed of at least a first pumping mechanism based at least in part on the signal indicative of the pressure of at least the permeate output of the reverse osmosis system;
wherein the first pumping mechanism comprises at least one of:
a fluid input coupled to at least the permeate output of the reverse osmosis system; and
a fluid output coupled to at least the feed input of the reverse osmosis system.

11. The method of claim 10, wherein adjusting the speed of at least the first pumping mechanism comprises increasing or decreasing the speed of at least the first pumping mechanism from a first non-zero value to a second non-zero value without enabling or disabling at least the first pumping mechanism.

12. The method of claim 10, wherein the speed of the at least first pumping mechanism is adjusted so as to maintain the pressure of at least the permeate output of the reverse osmosis system at a substantially constant level.

13. The method of claim 12, wherein the pressure of at least the permeate output of the reverse osmosis system is maintained within a range of approximately 3 pounds per square inch (psi) and 5 psi.

14. A method for use with a filtration system comprising at least a given fluid input and at least a given fluid output, said method comprising:
measuring a pressure of at least the given fluid input of the filtration system;
measuring a pressure of at least the given fluid output of the filtration system;
generating a signal indicative of a difference between the pressure of at least the given fluid input of the filtration system and the pressure of at least the given fluid output of the filtration system.

15. The method of claim 14, wherein the signal is indicative of a condition of at least one filter within the filtration system.

16. The method of claim 14, wherein the filtration system comprises a reverse osmosis filter;
wherein the reverse osmosis filter comprises a permeate output and a concentrate output; and
wherein the signal is indicative of the difference between the pressure of at least one input of the reverse osmosis filter and the pressure of at least the permeate output of the reverse osmosis filter.

17. The method of claim 14, wherein the filtration system comprises at least one pretreatment filter within a reverse osmosis system;
wherein the given fluid output of the filtration system is coupled to at least one input of a reverse osmosis filter within the reverse osmosis system; and
wherein the signal is indicative of the difference between a pressure of at least one input of the at least one pretreatment filter and the pressure of at least one output of the at least one pretreatment filter.

18. The method of claim 14, further comprising:
adjusting a speed of at least a first pumping mechanism based at least in part on the signal indicative of the difference between the pressure of at least the given fluid input of the filtration system and the pressure of at least the given fluid output of the filtration system;
wherein the first pumping mechanism is coupled to at least one of the given fluid input and the given fluid output of the filtration system.

19. The method of claim 18, wherein the first pumping mechanism comprises at least one of:
a fluid input coupled to at least the given fluid output of the filtration system; and
a fluid output coupled to at least the given fluid input of the filtration system.

20. The method of claim 18, wherein the speed of the at least first pumping mechanism is adjusted so as to maintain the difference between the pressure of at least the given fluid input of the filtration system and the pressure of at least the given fluid output of the filtration system at a substantially constant level.

21. The method of claim 14, further comprising transmitting the signal over at least one of a wired and a wireless connection to facilitate remote monitoring of the filtration system.

22. The method of claim 14, further comprising recording multiple values of the signal at differing times on a storage medium to facilitate detection of variations in the signal in order to monitor the filtration system.

23. A reverse osmosis filtration system comprising:
a feed input;
a concentrate output;
a permeate output;
at least a first pumping mechanism, a fluid output of the first pumping mechanism being coupled to the feed input;
at least one pressure sensor operative to measure a pressure of the permeate output and to generate a signal indicative of the pressure of the permeate output; and
at least one controller operative to adjust a speed of at least the first pumping mechanism based at least in part on the signal indicative of the pressure of the permeate output;
wherein at least one of a current and a voltage of the signal generated by the at least one pressure sensor is at least in part proportional to the pressure of the permeate output; and
wherein adjusting the speed of at least the first pumping mechanism comprises increasing or decreasing the speed of at least the first pumping mechanism from a first non-zero value to a second non-zero value without enabling or disabling at least the first pumping mechanism.

24. The reverse osmosis filtration system of claim 23, wherein the at least one controller is further operative to adjust a speed of at least a second pumping mechanism based at least in part on the signal indicative of the pressure of the permeate output;
wherein at least the second pumping mechanism comprises a fluid input coupled to the permeate output; and
wherein a fluid output of at least the second pumping mechanism is coupled to an input of at least one fluid storage device.
